(19) United States
(12) Patent Application Publication
(10) Pub. No.: US 2024/0020463 A1
(43) Pub. Date: Jan. 18, 2024

(54) TEXT BASED CONTEXTUAL AUDIO ANNOTATION

(71) Applicant: Cisco Technology, Inc., San Jose, CA (US)

(72) Inventors: Pål-Erik S. Martinsen, As (NO); Edel Joyce, Galway (IE); Richard Logan, Wiltshire (GB); Mags Moran, Galway (IE); Stewart Curry, Dublin (IE)

(21) Appl. No.: 17/865,539

(22) Filed: Jul. 15, 2022

(51) Int. Cl. G06F 40/169; H04L 65/403; G10L 15/26

(52) U.S. Cl. CPC G06F 40/169; H04L 65/403; G10L 15/26

(57) ABSTRACT

An annotated comment provides context for user comments in an online conference. A conference device obtains online conference data from an online conference between user endpoints, and provides an output of the online conference data to a user device. The conference device obtains a user comment from a user interface of the user device, and obtains a transcribed context portion of the online conference data. The conference device generates an annotated comment including the user comment and the transcribed context portion, and adds the annotated comment to the online conference data.

### TECHNICAL FIELD

The present disclosure relates to online conferencing, and providing user comments to online conferences.

### BACKGROUND

Online conferences typically allow for collaboration between multiple people across multiple modes of communication. Online conferences may include audio, video, text, whiteboard drawings, document sharing, or other types of shared data. Translating between different modes of online conference communication may be accomplished through different means, such as Speech-To-Text (STT) or Natural Language Processing (NLP). For instance, automatic captions displayed on video conferences allow a viewer to experience the audio portion of the conference by reading a transcribed version of audio.

### BRIEF DESCRIPTION OF THE DRAWINGS

FIG. 1 is simplified block diagram of an online conferencing system configured to facilitate communication between endpoint devices, according to an example embodiment.

FIG. 2A is a simulated screenshot of a user interface for incorporating a transcribed audio portion as context for a text comment, according to an example embodiment.

FIG. 2B is a simulated screenshot of a user interface illustrating how a user can change the transcribed context for a text comment, according to an example embodiment.

FIG. 2C is a simulated screenshot of a user interface illustrating a user comment and transcribed context that is posted to a text channel of an online conference, according to an example embodiment.

FIG. 3 is a flowchart illustrating operations performed by an online conference device to incorporate transcribed audio to a text comment, according to an example embodiment.

FIG. 4 is a flowchart illustrating operations performed by an online conference device to generate a text comment annotated with a selected transcribed portion of audio from the online conference, according to an example embodiment.

FIG. 5 is a block diagram of a computing device that may be configured to perform the techniques presented herein, according to an example embodiment.

### DESCRIPTION OF EXAMPLE EMBODIMENTS

### Overview

A method is provided to provide context to user comments in an online conference. The method includes obtaining online conference data from an online conference between a plurality of user endpoints, and providing an output of the online conference data to a user device. The method also includes obtaining a user comment from a user interface of the user device, and obtaining a transcribed context portion of the online conference data. The method further includes generating an annotated comment including the user comment and the transcribed context portion. The method also includes adding the annotated comment to the online conference data.

### EXAMPLE EMBODIMENTS

During an online conference, a user may not want to directly interrupt a presenter with the question, potentially disrupting the flow of the online conference. The user may prefer to wait until an appropriate time later in the presentation, but waiting to ask a question may lose some of the contemporaneous context for the question. Additionally, some online conferences may mute many of the participants during a presentation, preventing those participants from providing feedback during the presentation. Other participants may be uncomfortable speaking up to ask a question, particularly in front of a large or unfamiliar audience.

Different modes of communication may provide different advantages during the online conference. For instance, a text channel of the online conference may provide a better forum for participants to ask questions without interrupting a presenter. The techniques described herein provide a non-intrusive way to ask questions during an online conference while maintaining context cues that are relevant to the question. Additionally, the techniques presented herein may be applied to include context for user comments that are generated either during the online conference or during a replay of the online conference. Further, the option of responding to transcribed audio provides inclusivity for users (e.g., users who are deaf or hard of hearing, foreign language speakers, etc.) who face challenges with following oral discussions.

To provide the context for user comments/questions, the techniques presented herein describe adding a transcribed portion of the audio that was being shared at the time the user comment is generated. In other words, a transcript of a selected portion the audio content of the online conference provides context for user comments in a text portion of the online conference. In one example, the audio portion of the online conference data is transcribed through a Speech-To-Text (STT) service in response to the generation of a user comment to facilitate the context annotation. Alternatively, the audio data may be continuously transcribed, e.g., for automatic captioning, and a specific portion of audio transcription may be selected to provide context for a user comment.

In another example, the techniques presented herein may be used when taking personal notes or meeting minutes. The notes/minutes may be taken through a pen-based or a keyboard-based input. A variety of user comments (e.g., notes, questions, reminders, action items, etc.) may be added to the online conference data along with transcribed audio providing context for the user comments. Additionally, the user comments may be added during the online conference and/or after the conclusion of the online conference. For instance, a user who was not able to attend online conference when it was live may access a saved version of the online conference and provide user comments with the transcribed audio as context for the user comments.

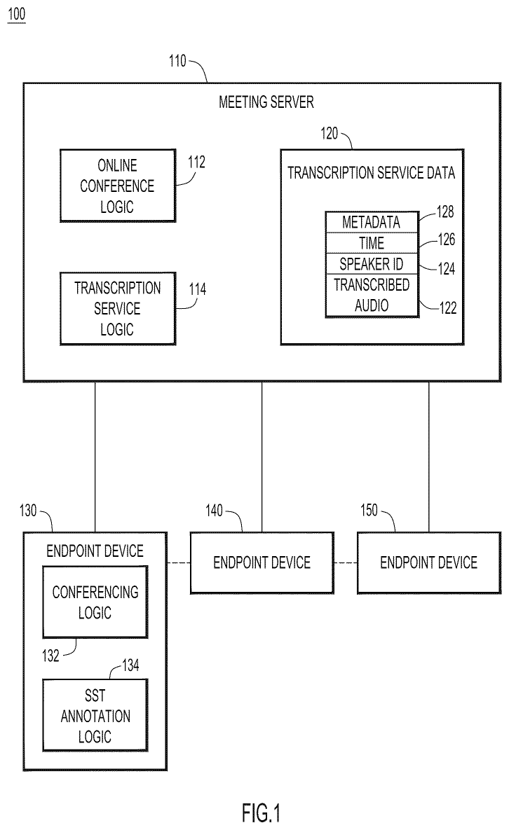

Referring now to FIG. 1, an online conference system 100 that enables user comments in a text channel to include transcribed speech from an audio channel. The online conference system includes a meeting server 110 with online conferencing logic 112 and transcription service logic 114. The online conferencing logic 112 enables the meeting server 110 to facilitate an online conference between two or more endpoint devices across a plurality of communication modes (e.g., video, audio, text, etc.). The transcription service logic 114 enables the meeting server 110 to transcribe audio from the online conference. In one example, the transcription service logic 114 operates throughout the online conference (e.g., to provide automatic captions in a video portion of the online conference). Alternatively, the transcription service logic 114 may be operated specifically in response to a user command or in response to a user comment being generated.

The meeting server 110 also includes transcription service data 120. The transcription service data 120 may include one or more instances of transcribed audio 122. Each instance of transcribed audio 122 may be associated with a speaker identifier 124, a time stamp 126, and/or other metadata 128. In one example, the speaker identifier 124 may identify one or more individual persons who contributed to the audio signal leading to the transcribed audio 122. Additionally, the speaker identifier 124 may identify the endpoint device from which the audio was captured.

In another example, the metadata 128 may include additional information about the online conference, the endpoint devices in the online conference, and/or the users of the endpoint devices. Additionally, the metadata 128 may include information about the audio recording used to generate the transcribed audio 122, such as an encoding format, volume levels, and/or background noise filter coefficients.

The online conference system 100 also includes an endpoint device 130 with conferencing logic 132 and STT annotation logic 134. The conferencing logic 132 enables the endpoint device 130 to communicate in an online conference. In one example, the conferencing logic 132 may enable the endpoint device 130 to perform some or all of the functions of the meeting server 110. For instance, the conferencing logic 132 may perform similar functions to the online conferencing logic 112 and the transcription service logic 114, enabling the endpoint device 130 to directly coordinate the online conference with other endpoint device without an intermediary meeting server.

The STT annotation logic 134 enables the endpoint device 130 to attach transcribed audio context generated from STT logic (e.g., transcription service logic 114) as an annotation to a user generated comment, as described herein. In one example, the STT annotation logic 134 obtains transcription service data 120 from the meeting server 110. The STT annotation logic 134 may include the transcribed audio 122, the speaker identifier 124, the time stamp 126, and/or the metadata 128 as part of the annotated user comment.

The online conference system 100 also includes endpoint device 140 and endpoint device 150, which may include similar logic to the endpoint device 130 (e.g., conferencing logic 132 and STT annotation logic 134). In one example, the endpoint devices 130, 140, and 150 may be connected to each other and/or the meeting server 110 through one or more computer networks.

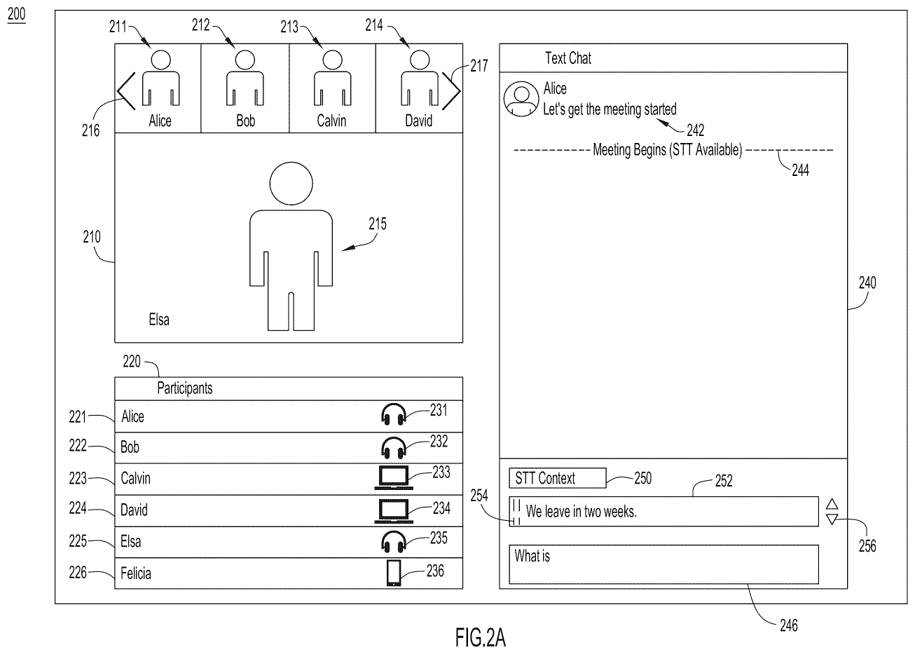

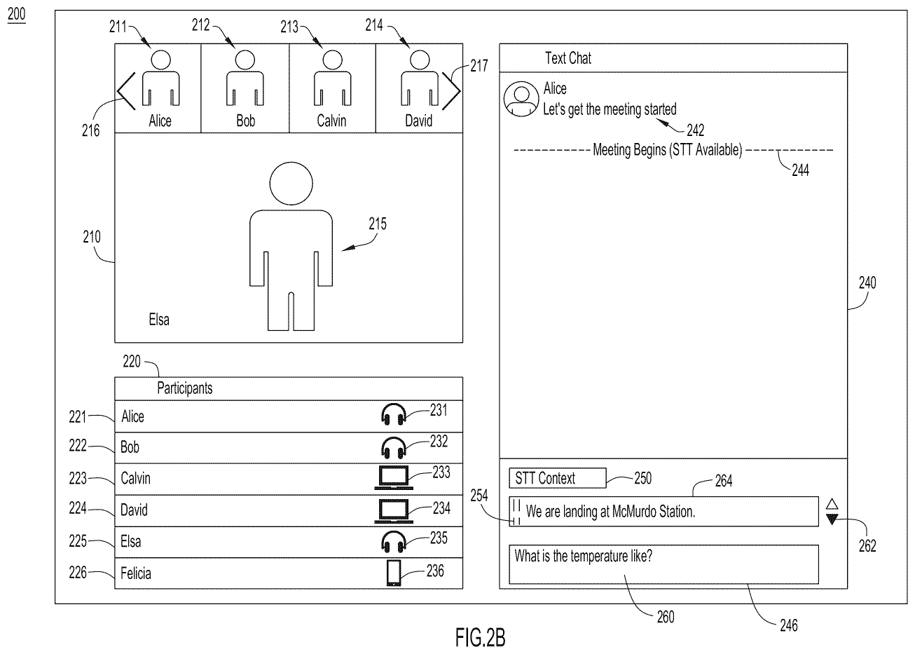

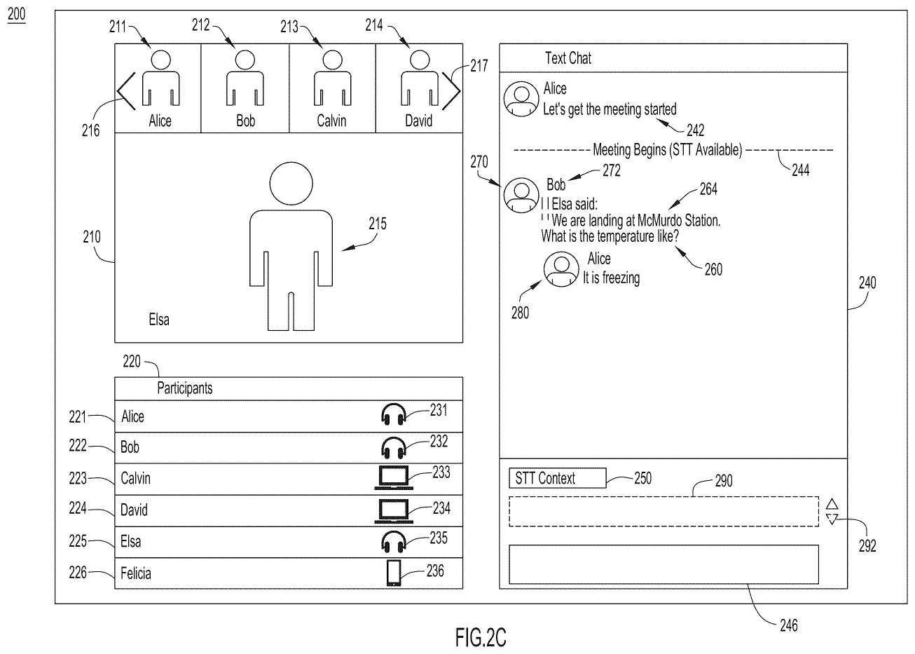

Referring now to FIG. 2A, a simulated screenshot illustrates a user interface 200 for annotating a user comment with context from a transcription service. The user interface 200 includes a video interface 210 that is shows images of the participants in an online conference. The video interface 210 shows a user image 211 (e.g., Alice), user image 212 (e.g., Bob), user image 213 (e.g., Calvin), user image 214 (e.g., David), and user image 215 (e.g., Elsa). In one example, the user image 215 is presented larger than the user images 211-214 because Elsa is currently the presenter. For instance, Elsa may be actively speaking, which the online conferencing logic uses the determine that the user image 215 represents the current focus of the online conference. In another example, the online conferencing logic may designate one or more users as the presenter and maintain the corresponding user image (e.g., user image 215) as the focus of the video interface 210 regardless of speaking activity.

The video interface 210 also includes interface elements 216 and 217 that allow a user to scroll through user images of additional participants. For instance, the video interface 210 may limit the number of displayed user images to allow each displayed user image to maintain a predetermined minimum size.

The user interface 200 also includes a participant list 220 that lists the name of the participants in the online conference. The participant list 220 includes a participant 221 (e.g., Alice), participant 222 (e.g., Bob), participant 223 (e.g., Calvin), participant 224 (e.g., David), participant 225 (e.g., Elsa), and participant 226 (e.g., Felicia). Each entry on the participant list 220 also includes metadata (e.g., an indication of how each participant is connected to the online conference) associated with the participant. For instance, indicator 231, indicator 232, and indicator 235 show that participant 221, 222, and 225 are connected to the audio portion of the online conference via headphones. Similarly, indicator 233 and indicator 234 show that participant 223 and participant 224 are connected to the audio portion of the online conference via a laptop. Indicator 236 shows that participant 226 is connected to the audio portion of the online conference via a smart phone. While the metadata indicators 231-236 shown in FIG. 2A specifically depict the audio connection, other types of metadata (e.g., mute status, active audio status, away status, etc.) may also be displayed in the participant list.

The user interface 200 further includes a text interface 240 that allows participants to exchange chat messages associated with the online conference. The text interface 240 includes a posted user comment 242, conference metadata 244, and a text entry interface 246. Additional user comments may be posted (e.g., in chronological order) in the text interface after the posted user comment 242. In one example, the conference metadata 244 illustrates an official beginning of the online conference, which may include the availability of additional conferencing services (e.g., STT services).

The text interface 240 also includes a context element 250 that is configured to initiate the STT quote reply feature described herein. The context element 250 enables a context portion 252 with a transcribed audio portion of the online conference data. In one example, the context portion 252 is automatically enabled when a user begins a user comment in the text entry interface 246. The context portion 252 prefaces the transcribed text with an indicator 254 to show that the transcribed text is generated from the audio portion of the online conference. A context switching element 256 enables a user to select a different portion of the transcribed text to include as an annotation to the user comment entered into the text entry interface 246.

In one example, the online conferencing logic may provide a suggested context portion 252. For instance, the online conferencing logic may suggest a specific context portion 252 based on the timing of a user interacting with the context element 250. Alternatively, the suggested context portion 252 may be based on the timing and/or content of the user comment entered into the text entry interface 246.

Referring now to FIG. 2B, a simulated screenshot illustrates how user interface 200 enables a user to select a different context portion to annotate a user comment 260. By engaging the context switching element 262, a user can change the context portion 264 to reflect an appropriate context for the user comment 260. The context switching element 262 may allow the user to change the context portion 264 at any point while composing the user comment 260 or after completing the user comment 260.

In one example, the context switching element 262 selects an earlier time frame or later time frame of the audio data from the online conference data to transcribe. For instance, a user may scroll forward or backward through the STT transcript of the online conference to select a sentence that provides a more appropriate context for the user comment 260 than an automatically suggested context portion.

In another example, the context switching element 262 may enable the user to increase or decrease the length of the context portion 264. For instance, the user may select multiple sentences for the context portion 264 if a single sentence does not provide sufficient context for the user comment 260.

In a further example, the context switching element 262 may enable the user to select a context portion 264 from a different speaker if the audio portion of the online conference is labeled with speaker identities. For instance, if multiple people are talking, the transcription service may transcribe audio from each speaker and provide metadata with the transcribed audio to identify the speaker.

In still another example, the context switching element 262 may enable the user to edit the context portion 264. For instance, a user may correct an error from the transcription service or remove unnecessary language (e.g., nervous vocalizations) from the context portion 264. To address potential security concerns, edits to the context portion 264 may be limited to minor changes. Additionally, the video portion of the online conference may provide additional evidence to resolve disputes regarding the authenticity of any edits to the context portion 264.

Referring now to FIG. 2C, a simulated screenshot illustrates how user interface 200 posts an annotated comment 270 to the text interface 240 of the online conference. Once the user selects the context portion 264 and submits the user comment 260, the endpoint device generates an annotated comment 270 that includes a user identifier 272 along with the selected context portion 264 and the user comment 260. The endpoint device provides the annotated comment 270 to the online conferencing logic, which propagates the annotated comment 270 to the other endpoint devices in the online conference.

In one example, another endpoint device may provide a reply comment 280 that directly addresses the annotated comment 270. Additional comments, with or without transcribed audio context, may continue in the text interface. In this way, the linear format of an online conference with a prepared agenda and schedule may transition to a tree structured discussion with branches rooted in various points of the online conference. The text discussions may extend beyond the original online conference and may include commentary from users who were not in the live online conference.

Once the endpoint device has posted the annotated comment 270 to the text interface 240, the text interface 240 may remove the context portion 290 and the context switching element 292 until the user begins another user comment. Alternatively, the context portion 290 may provide a running transcription of the audio portion of the online conference, and the context switching element 292 may enable a user to review the transcribed audio, e.g., by scrolling through transcribed audio portions. In one example, the context switching element 292 may enable the user to pre-select a new context portion 290 before entering a new user comment in the text entry interface 246.

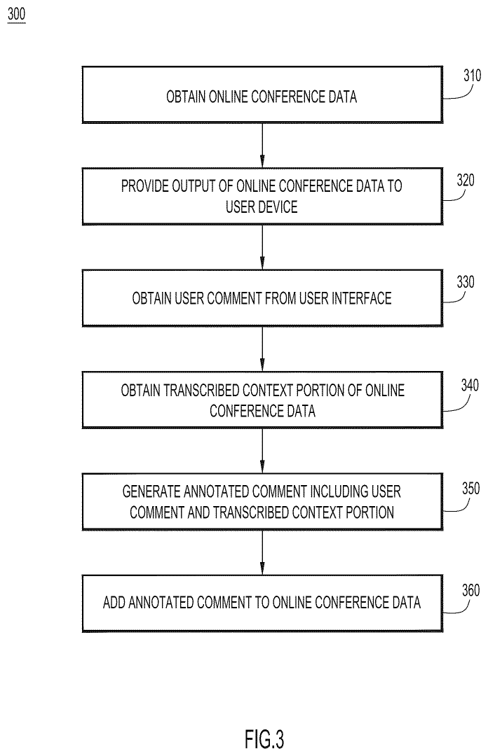

Referring now to FIG. 3, a flowchart illustrates an example process 300 performed by a device with online conferencing logic (e.g., online conferencing logic 112 or conferencing logic 132) to incorporate transcribed audio into a text user comment. At 310, the device obtains online conference data. In one example, the device may obtain the online conference data from a meeting server or from an endpoint device in the online conference. In another example, the online conference data may include audio data, video data, and/or text data. The device provides an output of the online conference data to a user device at 320. In one example, the output may include generating images and sound through one of the endpoint devices participating in the online conference. Alternatively, the user device may be a computing device that outputs the online conference data after the conclusion of the online conference. In other words, the user device providing the annotated user comment may be one of the participants in the online conference, or the user device may be a computing device that is viewing a saved version of the online conference.

At 330, the device obtains a user comment from a user interface. In one example, the user comment may be a question related to a particular portion of the online conference. For instance, a user may want clarification on a task, or elaboration on a topic of interest discussed in the online conference. The user comment may also include an indication that the user wants to include some context from the audio portion of the online conference.

At 340, the device obtains one or more transcribed context portions of the online conference data. In one example, the device obtains the transcribed context portion from a separate transcription service (e.g., an STT service). The transcription service may be running locally on the device or remotely on a separate device (e.g., a cloud-based server). Alternatively, the device may generate the transcribed context portion from the audio portion of the online conference data. In another example, the device may obtain the transcribed context portion from an ongoing captioning service for the online conference. Alternatively, the device may obtain the transcribed context portion in response to obtaining the user comment. In a further example, the device may enable a user to adjust the transcribed context portion (e.g., to an earlier or later time frame, to a larger or smaller time frame, to correct transcription errors, etc.)

At 350, the device generates an annotated comment comprising the user comment and the transcribed context portion. In one example, the annotated comment also includes metadata from the user comment or the transcribed context portion. For instance, the annotated comment may include an identification of the speaker who provided the audio for the transcribed context portion and/or an identification of the user who provided the user comment. Additionally, the annotated comment may include time stamps of the transcribed context portion and/or the user comment. At 360, the device adds the annotated comment to online conference data, and the annotated comment is propagated to the endpoints of the online conference. In one example, the annotated comment may be added to a text/chat portion of the online conference data.

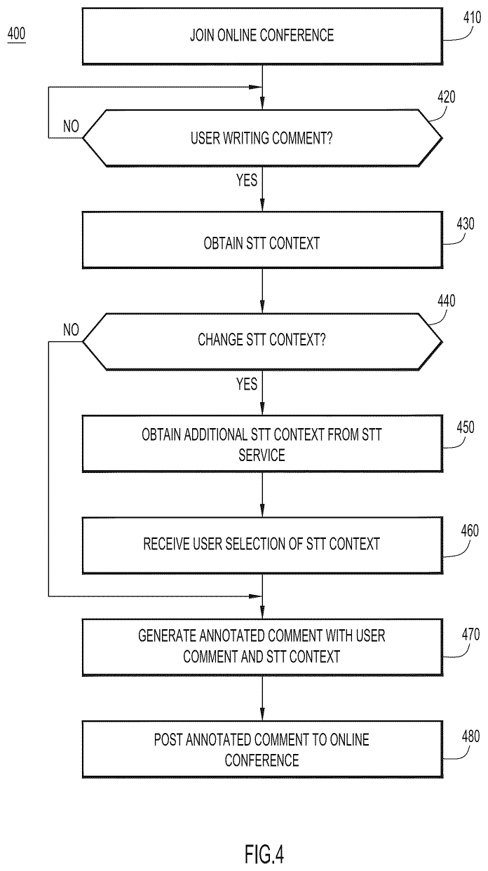

Referring now to FIG. 4, a flowchart illustrates an example process 400 performed by an endpoint device to provide STT context for user comments. At 410, the endpoint device joins an online conference. In one example, the endpoint device may be associated with one or more authorized participants of the online conference. When the endpoint device detects that a user is writing a comment, as determined at 420, then the endpoint device obtains the STT context for the comment at 430. In one example, the endpoint device may detect keystrokes or input from a touch sensitive pad. For instance, the endpoint device may have an input interface that recognizes handwritten comments from a stylus on a touch sensitive pad.

In another example, the endpoint device obtains the STT context from an STT service, which may be running throughout the online conference. Additionally, the STT context provided to the endpoint device may be based on the timing of the user comments. For instance, the STT service may provide the last sentence spoken before the user began entering the user comment. Further, the STT context may be based on the content of the user comment. For instance, a user questioning a specific term (e.g., “What does taxonomy mean?”) may cause the STT context to include transcribed audio that includes the specific term (e.g., “The taxonomy of snow enables advances in understanding Antarctic ecology.”).

At 440, the endpoint device provides the user an opportunity to change or adjust the STT context. If the user chooses to adjust the STT context, the endpoint device obtains additional STT context from the STT service at 450. In one example, the endpoint device may allow the user to scroll backward or forward through a transcript of the online conference audio to select an appropriate STT context. Additionally, a Natural Language Processing (NLP) system may suggest an appropriate STT context from the transcript of the online conference based on the content of the user comment.

In another example, the endpoint device may allow the user to include longer STT context (e.g., multiple sentences) or shorter STT context (e.g., sentence fragments). Additionally, the endpoint device may allow the user to edit the STT context (e.g., to correct transcription errors). At 460, the endpoint device receives the user selection of the appropriate STT context, finalizing the change in the STT context.

At 470, the endpoint device generates an annotated comment incorporating the user comment and the STT context. In one example, the annotated comment also includes metadata from the STT context, such as who spoke the words in the STT context or a time stamp for the STT context. The endpoint device posts the annotated comment to the online conference at 480. In one example, the annotated comment is added to a chat interface of the online conference, which allows other participants in the online conference to react and respond to the annotated comment.

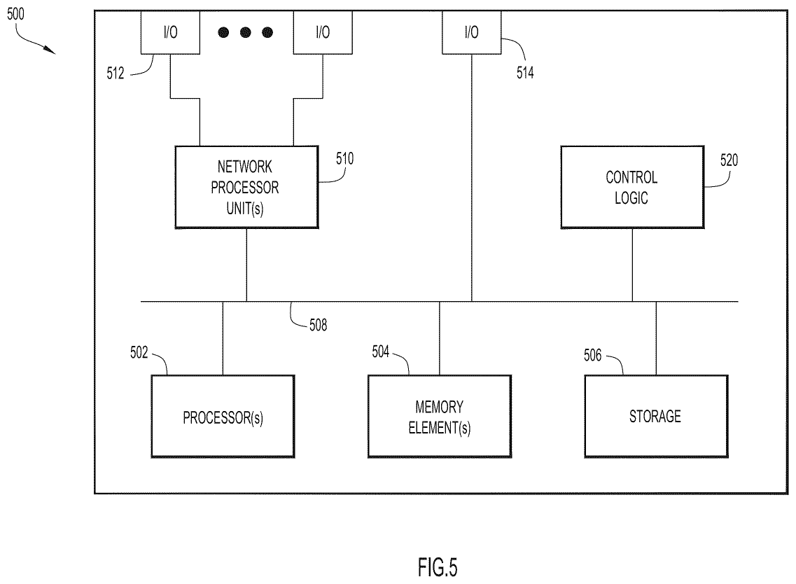

Referring to FIG. 5, FIG. 5 illustrates a hardware block diagram of a computing device 500 that may perform functions associated with operations discussed herein in connection with the techniques depicted in FIGS. 1, 2A, 2B, 2C, and 3-5. In various embodiments, a computing device, such as computing device 500 or any combination of computing devices 500, may be configured as any entity/entities as discussed for the techniques depicted in connection with FIGS. 1, 2A, 2B, 2C, and 3-5 in order to perform operations of the various techniques discussed herein.

In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In summary, the techniques presented herein take a selectable snippet of audio from an online meeting, convert the snippet to text, and add this context to meeting questions and notes. The additional context creates a deeper connection between the spoken word and the written word, and improves the flow of the meeting. For instance, in a meeting such as panel discussion, questions may be asked faster than panelists are able to answer. Providing contemporaneous audio context for the question may assist the panelists in answering questions at a later time.

Additionally, combining audio and text collaboration accommodates diverse work styles and physical abilities of the participants the online meeting. Crossing communication mediums and boundaries caters to a wider, more diverse audience, and promotes inclusivity in a work environment. Some people may be more comfortable asking questions and providing feedback via text, especially for meetings with a large audience.

In some aspects, the techniques described herein relate to a method including: obtaining online conference data from an online conference between a plurality of user endpoints; providing an output of the online conference data to a user device; obtaining a user comment from a user interface of the user device; obtaining a transcribed context portion of the online conference data; generating an annotated comment including the user comment and the transcribed context portion; and adding the annotated comment to the online conference data.

In some aspects, the techniques described herein relate to a method, further including adjusting the transcribed context portion based on input received at the user device.

In some aspects, the techniques described herein relate to a method, wherein adjusting the transcribed context portion includes selecting an earlier time frame or a later time frame of the online conference data from which the transcribed context portion is generated.

In some aspects, the techniques described herein relate to a method, wherein adjusting the transcribed context portion includes editing text in the transcribed context portion.

In some aspects, the techniques described herein relate to a method, wherein adjusting the transcribed context portion includes increasing or decreasing a length of the transcribed context portion.

In some aspects, the techniques described herein relate to a method, wherein the user comment is received after a conclusion of the online conference.

In some aspects, the techniques described herein relate to a method, wherein the user device is among the plurality of user endpoints.

In some aspects, the techniques described herein relate to a method, wherein generating the annotated comment includes adding metadata from the online conference data about the transcribed context portion.

In some aspects, the techniques described herein relate to an apparatus including: a network interface configured to communicate with computing devices in a computer network; a user interface configured to interact with a user of the apparatus; and a processor coupled to the network interface and the user interface, the processor configured to: obtain online conference data via the network interface, wherein the online conference data is from an online conference between a plurality of user endpoints; provide an output of the online conference data to the user interface; receive a user comment from the user interface; obtain a transcribed context portion of the online conference data; generate an annotated comment including the user comment and the transcribed context portion; and add the annotated comment to the online conference data.

In some aspects, the techniques described herein relate to an apparatus, wherein the processor is further configured to adjust the transcribed context portion based on input received from the user interface.

In some aspects, the techniques described herein relate to an apparatus, wherein the processor is configured to adjust the transcribed context portion by selecting an earlier time frame or a later time frame of the online conference data from which the transcribed context portion is generated.

In some aspects, the techniques described herein relate to an apparatus, wherein the processor is configured to adjust the transcribed context portion by editing text in the transcribed context portion.

In some aspects, the techniques described herein relate to an apparatus, wherein the apparatus is among the plurality of user endpoints.

In some aspects, the techniques described herein relate to an apparatus, wherein the processor is further configured to add metadata from the online conference data about the transcribed context portion when generating the annotated comment.

In some aspects, the techniques described herein relate to one or more non-transitory computer readable storage media encoded with software including computer executable instructions that, when the software is executed on a user device, is operable to cause a processor of the user device to: obtain online conference data from an online conference between a plurality of user endpoints; provide an output of the online conference data to a user interface of the user device; receive a user comment from the user interface of the user device; obtain a transcribed context portion of the online conference data; generate an annotated comment including the user comment and the transcribed context portion; and add the annotated comment to the online conference data.

In some aspects, the techniques described herein relate to one or more non-transitory computer readable storage media, wherein the software is further operable to cause the processor to adjust the transcribed context portion based on input received at the user device.

In some aspects, the techniques described herein relate to one or more non-transitory computer readable storage media, wherein the software is further operable to cause the processor to adjust the transcribed context portion by selecting an earlier time frame or a later time frame of the online conference data from which the transcribed context portion is generated.

In some aspects, the techniques described herein relate to one or more non-transitory computer readable storage media, wherein the software is further operable to cause the processor to adjust the transcribed context portion by editing text in the transcribed context portion.

In some aspects, the techniques described herein relate to one or more non-transitory computer readable storage media, wherein the software is further operable to cause the processor to receive the user comment after a conclusion of the online conference.

In some aspects, the techniques described herein relate to one or more non-transitory computer readable storage media, wherein the software is further operable to cause the processor to add metadata from the online conference data about the transcribed context portion when generating the annotated comment.

Each example embodiment disclosed herein has been included to present one or more different features. However, all disclosed example embodiments are designed to work together as part of a single larger system or method. The disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining online conference data from an online conference between a plurality of user endpoints;
providing an output of the online conference data to a user device;
obtaining a user comment from a user interface of the user device;
obtaining a transcribed context portion of the online conference data;
generating an annotated comment comprising the user comment and the transcribed context portion; and
adding the annotated comment to the online conference data.

2. The method of claim 1, further comprising adjusting the transcribed context portion based on input received at the user device.

3. The method of claim 2, wherein adjusting the transcribed context portion includes selecting an earlier time frame or a later time frame of the online conference data from which the transcribed context portion is generated.

4. The method of claim 2, wherein adjusting the transcribed context portion includes editing text in the transcribed context portion.

5. The method of claim 2, wherein adjusting the transcribed context portion includes increasing or decreasing a length of the transcribed context portion.

6. The method of claim 1, wherein the user comment is received after a conclusion of the online conference.

7. The method of claim 1, wherein the user device is among the plurality of user endpoints.

8. The method of claim 1, wherein generating the annotated comment includes adding metadata from the online conference data about the transcribed context portion.

9. An apparatus comprising:
a network interface configured to communicate with computing devices in a computer network;
a user interface configured to interact with a user of the apparatus; and
a processor coupled to the network interface and the user interface, the processor configured to:
obtain online conference data via the network interface, wherein the online conference data is from an online conference between a plurality of user endpoints;
provide an output of the online conference data to the user interface;
receive a user comment from the user interface;
obtain a transcribed context portion of the online conference data;
generate an annotated comment comprising the user comment and the transcribed context portion; and
add the annotated comment to the online conference data.

10. The apparatus of claim 9, wherein the processor is further configured to adjust the transcribed context portion based on input received from the user interface.

11. The apparatus of claim 10, wherein the processor is configured to adjust the transcribed context portion by selecting an earlier time frame or a later time frame of the online conference data from which the transcribed context portion is generated.

12. The apparatus of claim 10, wherein the processor is configured to adjust the transcribed context portion by editing text in the transcribed context portion.

13. The apparatus of claim 9, wherein the apparatus is among the plurality of user endpoints.

14. The apparatus of claim 9, wherein the processor is further configured to add metadata from the online conference data about the transcribed context portion when generating the annotated comment.

15. One or more non-transitory computer readable storage media encoded with software comprising computer executable instructions that, when the software is executed on a user device, is operable to cause a processor of the user device to:
obtain online conference data from an online conference between a plurality of user endpoints;
provide an output of the online conference data to a user interface of the user device;
receive a user comment from the user interface of the user device;
obtain a transcribed context portion of the online conference data;
generate an annotated comment comprising the user comment and the transcribed context portion; and
add the annotated comment to the online conference data.

16. The one or more non-transitory computer readable storage media of claim 15, wherein the software is further operable to cause the processor to adjust the transcribed context portion based on input received at the user device.

17. The one or more non-transitory computer readable storage media of claim 16, wherein the software is further operable to cause the processor to adjust the transcribed context portion by selecting an earlier time frame or a later time frame of the online conference data from which the transcribed context portion is generated.

18. The one or more non-transitory computer readable storage media of claim 16, wherein the software is further operable to cause the processor to adjust the transcribed context portion by editing text in the transcribed context portion.

19. The one or more non-transitory computer readable storage media of claim 15, wherein the software is further operable to cause the processor to receive the user comment after a conclusion of the online conference.

20. The one or more non-transitory computer readable storage media of claim 15, wherein the software is further operable to cause the processor to add metadata from the online conference data about the transcribed context portion when generating the annotated comment.
